(19) United States
(12) Patent Application Publication
(10) Pub. No.: US 2024/0306252 A1
(43) Pub. Date: Sep. 12, 2024

(54) METHOD AND APPARATUS TO REDUCE SERVICE INTERRUPTION IN COMMUNICATION SYSTEM

(71) Applicant: SAMSUNG ELECTRONICS CO., LTD., Suwon-si, Gyeonggi-do (KR)

(72) Inventors: Mahmoud WATFA, Staines (GB); Lalith KUMAR, Bangalore (IN)

(21) Appl. No.: 18/260,769

(22) PCT Filed: Jan. 11, 2022
(86) PCT No.: PCT/KR2022/000452

§ 371 Date: Jul. 7, 2023

(30) Foreign Application Priority Data
Jan. 11, 2021 (IN) 202131001217
May 13, 2021 (IN) 202131021655
Jan. 10, 2022 (GB) 2200218.2

(51) Int. Cl. H04W 76/50; H04W 4/90; H04W 48/16

(52) U.S. Cl. CPC H04W 76/50; H04W 4/90; H04W 48/16

(57) ABSTRACT

A method of a user equipment (UE) is provided. The method includes identifying a disaster condition for a first network, identifying whether the UE is in a registered state and a connected state over a first access based on the identified disaster condition, and performing a disaster roaming based on an identification that the UE is not in the registered state and the connected state over the first access.

### TECHNICAL FIELD

The disclosure relates to a method and an apparatus to reduce service interruption in a communication system. It may apply to, for example, to a fifth generation (5G) system, but the principles set out may be applicable to other communication system.

### BACKGROUND ART

The service interruption may be due to a so-called disaster condition (DC), such as partial network outage due to some form of natural disaster or other occurrence which disables at least part of a network.

The applicable standards document (TS 22.261) lists some requirements to avoid service interruptions that may arise when a DC (e.g. fire) occurs on a given public land mobile network (PLMN) and for which the user equipments (UEs) are to be redirected to another PLMN in a manner that keeps the service interruption to a minimum. The description of this included in this document states:

“A mobile network may fail to provide service in the event of a disaster (for example a fire.) The requirements listed in this clause provide the 5G System (5GS) with the capability to mitigate interruption of service. UEs may obtain service in the event of a disaster, if there are PLMN operators prepared to offer service. The minimization of service interruption is constrained to a particular time and place. To reduce the impact to the 5G System of supporting Disaster Roaming, the potential congestion resulting from an influx or outflux of Disaster Inbound Roamers is taken into account.”

The standards document continues to set out some more detailed requirements:

### “6.31.2 Requirements

### 6.31.2.1 General

Subject to regulatory requirements or operator's policy, 3GPP system shall be able to enable a UE of a given PLMN to obtain connectivity service (e.g. voice call, mobile data service) from another PLMN for the area where a Disaster Condition applies.

### 6.31.2.2 Disaster Condition

The 3GPP system shall enable UEs to obtain information that a Disaster Condition applies to a particular PLMN or PLMNs.

NOTE: If a UE has no coverage of its HPLMN, then obtains information that a Disaster Condition applies to the UE's HPLMN, the UE can register with a PLMN offering Disaster Roaming service.

The 3GPP system shall support means for a PLMN operator to be aware of the area where Disaster Condition applies.

The 3GPP system shall be able to support provision of service to Disaster Inbound Roamer only within the specific region where Disaster Condition applies.

The 3GPP system shall be able to provide efficient means for a network to inform Disaster Inbound roamers that a Disaster Condition is no longer applicable.

Subject to regulatory requirements or operator's policy, the 3GPP system shall support a PLMN operator to be made aware of the failure or recovery of other PLMN(s) in the same country when the Disaster Condition is applies, or when the Disaster Condition is not applicable.

### 6.31.2.3 Disaster Roaming

The 3GPP system shall be able to provide means to enable a UE to access PLMNs in a forbidden PLMN list if a Disaster condition applies and no other PLMN is available except for PLMNs in the forbidden PLMN list.

The 3GPP system shall provide means to enable that a Disaster Condition applies to UEs of a specific PLMN.

The 3GPP system shall be able to provide a resource efficient means for a PLMN to indicate to potential Disaster Inbound Roamers whether they can access the PLMN or not.

Disaster Inbound Roamers shall perform network reselection when a Disaster Condition has ended.

The 3GPP system shall minimize congestion caused by Disaster Roaming.

3GPP system shall be able to collect charging information for a Disaster Inbound Roamer with information about the applied disaster condition.”

Another standards document (TR 24.811) is the specification that is used to perform the study based on these requirements. This document captures certain key issues for which solutions will be developed and chosen for normative work when the study concludes.

It is assumed that a DC can occur on the radio access network (RAN) level for which e.g. the radio towers will be non-functional and hence the UE cannot connect to the PLMN in the area where the DC occurred. For example, consider FIG. 1 which shows examples of RAN nodes 1, 2, 3 that connect to the access & mobility management function (AMF)(20).

Normally, every cell (or RAN node, which may support multiple cells) broadcasts the tracking area identity (TAI) (e.g TAI #1 (101), TAI #2 (102) and TAI #3 (103)), or actually a tracking area code (TAC) in addition to the PLMN identity together which form the TAI of the cell. The UE identifies the PLMN ID (or TAI) of a cell, based on this information that is broadcast.

### Note:

$$PLMN ID = Mobile Country Code ( MCC ) + Mobile Network Code ( MNC )$$

$$TAI = PLMN ID + Tracking Area Code ( TAC ) = MCC + MNC + TAC$$

### DISCLOSURE OF INVENTION

### Technical Problem

As can be seen from the above, the service interruption is limited to a particular time and place and hence only the UEs that are in the given location at the given time of disaster will be impacted by the disaster condition and hence should be serviced by another PLMN.

A UE that registers to the 5GS will be provided with a registration area (RA) which consists of a set of TAIs (i.e. one or more TAIs) in which the UE is allowed to enter without performing a registration procedure except for periodic updating or other reasons. For example, if the UE registers and receives an RA that is composed of TAI #1 (101) and TAI #2 (102), then the UE can move from TAI #1 (101) to TAI #2 (102) in idle mode without sending a Registration Request. On the other hand, if the UE enters a new area that is not part of the UE's RA e.g. TAI #3 (103), then the UE is required to perform a registration procedure in order to get services, during which procedure the network will provide a new RA, assuming the UE is indeed allowed to use the service in TAI #3 (103).

When a DC occurs, the RAN nodes may be down and, as such, the UE may not receive any broadcast information and, as such, may not be able to receive any system information that would otherwise enable the UE to determine the PLMN ID or the TAI of the cell. In fact, the UE would not detect a cell when this occurs.

Note that this assumes that the DC impacts the RAN such that no information can be sent by the RAN and, as such, the UE cannot detect the presence of the cell as per normal methods.

As indicated earlier, a DC may be limited to a certain place and time. It is possible that the DC impacts one or more TAIs such as:
The area covered by TAI #1 (101) only, or TAI #2 (102) only, or TAI #3 (103) only
The area covered by one or more TAIs e.g. TAI #1 (101) and TAI #2 (102) only, or TAI #2 (102) and TAI #3 (103) only, or TAI #1 (101) and TAI #2 (102) and TAI #3 (103).

Note that the above is just an example to explain the place where a DC may occur.

Additionally, a TAI, or a set of TAIs, may also correspond to a particular geographic area that can be e.g. a set of geographical coordinates, where this set may for example define a particular shape such as a triangle, rectangle, or any other polygon, etc.

For example, the DC may span all the TAIs 1, 2, 3 shown in FIG. 2 such that the DC may be composed of a set of 4 coordinate points (P1, P2, P3, P4) (202) that define a rectangular shape that covers the cells that broadcast TAI #1 (101) to TAI #3 (103).

When a DC occurs, and the UE is aware of it, the UE will attempt to register on another PLMN, where this PLMN may be a visited PLMN (VPLMN) i.e. the PLMN may not be the UE's home PLMN (HPLMN). In fact, the UE may be allowed to use a PLMN in the list of forbidden PLMNs that the UE maintains.

When the UE registers on another PLMN where there is no DC, the UE can receive services from that PLMN, e.g. a target VPLMN, until the DC in its source PLMN (e.g. HPLMN or a previous source VPLMN) ends. The UE can then return to the previous PLMN.

As the number of UEs that go to a target PLMN due to a DC, or return to source PLMN after a DC ends, the requirements listed earlier require that this be done in a way that avoids congestion on a (target or source) PLMN that may result from a very large number of UEs attempting registration at the same time.

There are a number of problems associated with the prior art.

Firstly, there is a lack of methods to inform a UE about a DC. The following requirement was listed earlier:

“The 3GPP system shall enable UEs to obtain information that a Disaster Condition applies to a particular PLMN or PLMNs.”

### Solution to Problem

There are currently no solutions that have been adopted to satisfy the above requirement in general, and also for particular scenarios. Embodiments of the disclosure aim to provide solutions to satisfy the requirement that is listed above.

According to the disclosure there is provided an apparatus and method as set forth in the appended claims. Other features of the disclosure will be apparent from the dependent claims, and the description which follows.

Another aspect of the disclosure is to provide a method and an apparatus to reduce service interruption in a communication system.

In accordance with an aspect of the disclosure, a method of a user equipment (UE) is provided. The method includes identifying a disaster condition for a first network, identifying whether the UE is in a registered state and a connected state over a first access based on the identified disaster condition, and performing a disaster roaming based on an identification that the UE is not in the registered state and the connected state over the first access.

In accordance with another aspect of the disclosure, a user equipment (UE) is provided. The UE includes a transceiver, and at least one processor coupled to the transceiver. The at least one processor is configured to identify a disaster condition for a first network, identify whether the UE is in a registered state and a connected state over a first access based on the identified disaster condition, and control the transceiver to perform a disaster roaming based on an identification that the UE is not in the registered state and the connected state over a second access.

Although a few preferred embodiments of the disclosure have been shown and described, it will be appreciated by those skilled in the art that various changes and modifications might be made without departing from the scope of the invention, as defined in the appended claims.

### BRIEF DESCRIPTION OF DRAWINGS

For a better understanding of the invention, and to show how embodiments of the same may be carried into effect, reference will now be made, by way of example only, to the accompanying diagrammatic drawings in which:

FIG. 1 is an example configuration of a system related to a DC scenario in accordance with the prior art;

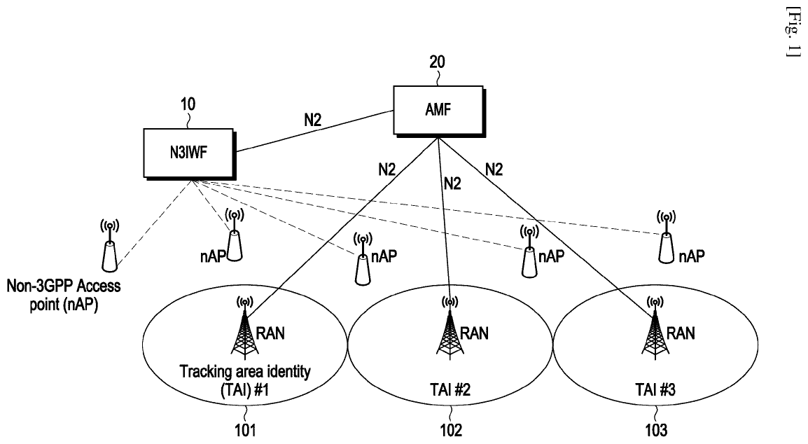

FIG. 2 is an example configuration of a system related to a DC scenario in accordance with the prior art;

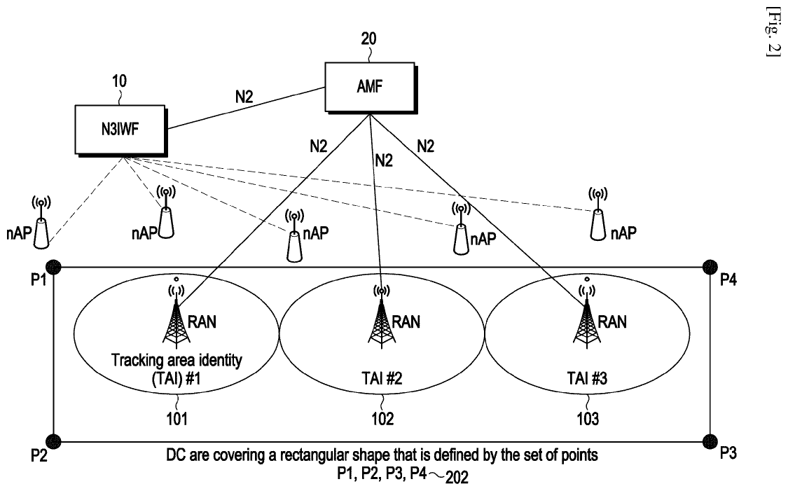

FIG. 3 is a message flow in accordance with various embodiments;

FIG. 4 is a message flow in accordance with various embodiments; and

FIG. 5 is a block diagram of a UE in accordance with various embodiments.

### MODE FOR THE INVENTION

A user equipment (UE) may be registered to the same public land mobile network (PLMN) over both the 3GPP access and the non-3GPP access. A disaster condition (DC) may then occur on one of the accesses e.g. 3GPP access, but not on the other access e.g. non-3GPP access.

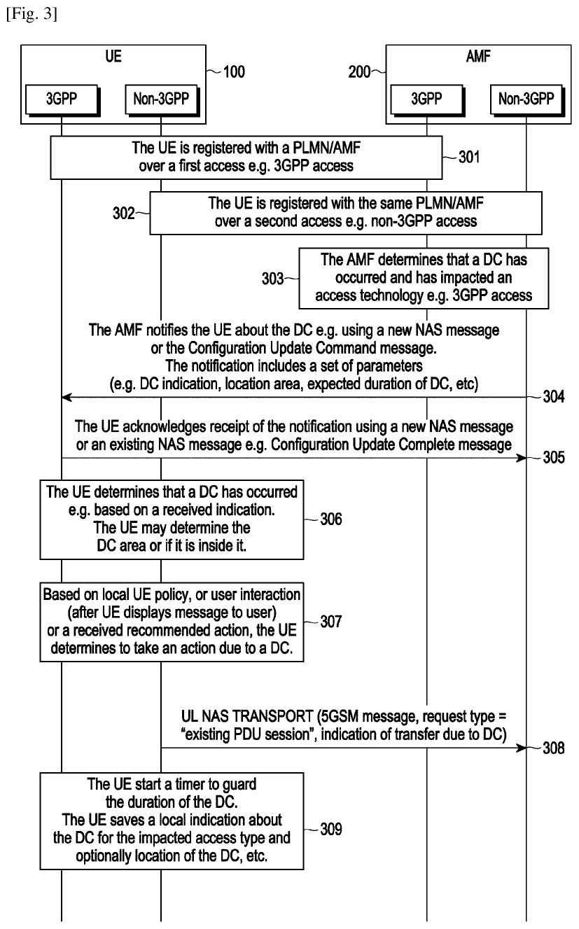

In such a situation, an embodiment of the disclosure provides a means by which the UE is aware of the DC that has occurred. FIG. 3 (described later in detail) shows an example of a UE that is in coverage of a non-3GPP access point (AP) and is registered over the non-3GPP access to a PLMN. Moreover, the UE is also in coverage of a radio access network (RAN) node (e.g. that broadcasts tracking area identity (TAI) #2) and is also registered to the same PLMN over the 3GPP access. The RAN node e.g. which broadcasts TAI #2, is assumed to have a DC and therefore may suddenly go out of service. The UE will not be able to detect the cell anymore and may not be in coverage of other cells e.g. the UE may not be able to detect the cells that broadcast TAI #1 or TAI #3. The UE may then repeatedly try to scan for the same PLMN which, in reality, cannot be found if the UE does not change its location to be close to the cell broadcasting TAI #1 or the cell that broadcasts TAI #3 or any other neighboring cell. For this scenario, the UE should be informed so that it does not waste battery power scanning for the same PLMN that is no longer available over the 3GPP access.

Note that the same issue can happen with the other access. For example, the DC may inflict the non-3GPP access only, or the non-3GPP access and 3GPP access as well.

In a first embodiment, there is provided a method of Informing the UE over one access means about a DC that relates to another access means. For instance, in the case of a UE connected by both 3GPP and non-3GPP means.

A UE (100) may be registered to the same PLMN (and optionally same access & mobility management function (AMF) (200)) over the 3GPP access and over the non-3GPP access.

The AMF (200) may determine that a DC has occurred in a specific area and has impacted a particular access type, hereafter referred to the impacted access type. For example, the impacted access type may be the 3GPP access. The UE (100) may be registered to the same PLMN (and optionally AMF (200)) over another access type which is not the impacted access type or which is the non-impacted access type. For example, the non-impacted access type may be the non-3GPP access.

When the AMF (200) detects a DC that affects an impacted access type, optionally if the UE is registered over a second access type that may be a non-impacted access type, the AMF (200) should notify the UE (100) over the non-impacted access type that a DC has occurred and has impacted a particular access type (e.g. the impacted access type). The notification may also include any combination of the following parameters:
A) The AMF may inform any UE that is in the area of the DC or outside the area of the DC. The AMF may inform the UE that is in connected mode or may e.g. page the UE over the 3GPP access to transition the UE to connected mode and then inform the UE about the DC
B) An indication of a DC, optionally with an access type where the access type can refer to the impacted access type. Note that there may be more than one access type that can be sent when the DC impacts more than one access type
C) The network may indicate the nature of the DC e.g. “fire”, “earthquake”, “flood”, etc. This may be done by using dedicated descriptions or bitmap where e.g. a bit position of a new IE can be defined to refer to a set of well-defined DC
D) A location information: where the information is not limited to one parameter only or one type of information only. This information may represent an area where a DC has occurred and over which service is temporarily not available (or over which normal service cannot be acquired). This information may be any combination of the following:
i) a list of TAs or TAIs
ii) global cell identities
iii) a list of CAG (close access group) identities
iv) Geographic coordinates and optionally a shape description e.g. “rectangle”, “hexagon”, etc, that represents the area (specified by the coordinates) that has been affected. This information may also contain a centre coordinate point and a radius parameter (or diameter parameter) to e.g. represent a circular area that may be impacted. Note that this is just an example and other parameters may also be used to represent other geographical areas and shapes
v) A set of GPS coordinates
E) A set of time parameters that explain or indicate any of the following:
i) A start time for the DC
ii) A period of time during which the DC is expected to last, or an end time at which the DC is expected to end
F) A set of PLMN identities, optionally in a priority order, where the order may be in descending priority or ascending priority. Each PLMN ID represents a target PLMN that the UE may use or access in order to get service
G) An action that the PLMN recommends the UE to do, where the action may be:
i) Remain on the current PLMN and use a different access technology. The action may further indicate or recommend moving any established PDU session from the impacted access technology and transferred over the non-impacted access technology
ii) Optionally attempt to access a PLMN, optionally using a list of prioritized PLMN as described above, using the access technology that is impacted. For example, if the impacted access technology is 3GPP access, then the recommended action may be that he UE should attempt to use (or access or register with/on) another PLMN using the 3GPP access
iii) Optionally a time value after which the recommended action may be taken by the UE. E.g. the timer value may be a value that the AMF (or current PMN) recommends that the UE waits before trying to register on another PLMN. This may be done in order to control the number of simultaneous access attempts on other PLMNs so as to avoid congestion in the target PLMN
iv) Whether or not the UE should transfer its PDU session(s) from the impacted access over to the non-impacted access. The indication may be in the form of a bitmap, where a new IE can be used for this bitmap and each bit may would correspond to a PDU session ID and the bit value would indicate whether the PDU session with the corresponding PDU session ID should be transferred. For example, the value ‘1’ may be used to mean that the PDU session corresponding to this bit should be transferred, and ‘0’ may mean that it should not be transferred. Note that this is just an example and other methods can be used to indicate whether a PDU session should be transferred or not

The AMF may optionally include a time value, optionally per PDU session ID or for all PDU sessions, that indicates a period of time that the network (e.g. AMF and/or Session Management Function (SMF)) will keep the PDU session as active and hence the UE can transfer the PDU session within this time. The AMF may start a timer with the indicated value (optionally after sending the notification to the UE), optionally per PDU session or for all PDU session. After the expiry of this timer, if the UE does not transfer the PDU session then the AMF, for each PDU session that was not transferred, will mark the PDU session as released and inform the SMF to also release the PDU session. On the other hand, if the UE transfers the PDU session(s) before the time expires, the AMF may stop the timer. Alternatively, the AMF may stop the timer when the UE transfers all of its PDU sessions from the impacted access over to the nonimpacted session
H) The AMF should also indicate the registration status (or registration result) of the UE in relation to, at least, the impacted access type. The AMF may do so using a new IE or an existing IE that can be sent in the NAS message:
i) For example, the AMF can send the 5GS registration result IE to indicate that the UE whether or not the UE is considered to be registered over the impacted access type
ii) For example, the AMF can use Deregistration type IE to indicate if the UE is considered to be deregistered over the impacted access type. In this case, bit 4 of the Deregistration type IE can be used by the AMF to indicate the reason for the deregistration. The reason may be “network disaster condition” or a more generic reason such as “service temporarily unavailable”
I) The AMF should send a new 5GMM cause value to indicate the reason why the notification (as explained and described above) is being sent. This cause value may be “network disaster condition” or a more generic reason such as “service temporarily unavailable”

The notification that should be sent to the UE may be any Non-Access Stratum (NAS) message, where the NAS message may be a new message or an existing NAS message. For example, the NAS message may be a Configuration Update Command message or the NOTIFICATION message. For example, the AMF may detect that the is a DC that has impacted an access type e.g. a 3GPP access. The AMF may determine that the UE is also registered over a second access type e.g. non-3GPP access. The AMF may optionally determine that the UE is in 5GMM-CONNECTED mode, optionally in the area of the DC. It is therefore proposed that the AMF should send a Configuration Update Command message to notify the UE about the DC on an impacted access e.g. the 3GPP access. Note that this may be performed if the UE's registration arca includes a TAI that is known to be within the location of the DC. This determination may be based on AMF implementation.

The AMF may also provide, in the NAS message (e.g. Configuration Update Command message) any combination of the parameters that are listed above.

Note that the notification may be sent using any other NAS such as the notification message or the deregistration request message.

Note that all of the above parameters may be sent using new IEs or using existing IEs and they may be sent in a new NAS message or an existing NAS message.

Next, the UE behaviour is described for the case after which the UE receives a notification of a DC as set out above.

Note that the UE may determine that a DC has occurred by receiving a notification about a DC from the network as set out above. The notification may be received in the form of a new NAS message or an existing NAS message with any combination of the above listed parameters.

When the UE receives a notification about a DC, e.g. by receiving a new or existing NAS message, with any combination of the parameters that are listed above, the UE may take any combination of the following actions:
A) The UE may send a NAS message to acknowledge the receipt of the notification. The acknowledgement may be done with a new NAS message or with existing NAS message e.g. Configuration Update Complete or Notification Response, etc.
B) The UE may determine the location of the DC based on the location information that is provided received. For example, the UE may receive geographical coordinates, and/or other parameters as described above, that the UE can use to determine the area of the DC. For example, the coordinates can be used to determine a shape or size of the area that is impacted by the DC. Moreover, the UE may use any method to determine its own location e.g. based on GPS, and may then determine its location relative to the area of the DC. The UE should then determine if it is in the area of the DC or not
C) The UE may display a message to the user to notify of the DC or the temporary service unavailability. The message may include the access type(s) that is impacted by the DC. The message may also indicate to the user whether the UE is inside or outside the area that is impacted by the DC. The UE may also display the nature of the disaster condition e.g. “fire”, “earthquake”, “flood”, where this display may be done using words or icons that represent a certain DC. This information may be based on the information that the UE has received, optionally as notified by the network based on the above. The UE may then receive a recommended action from the user e.g. to select another PLMN, or to use another access technology for the same PLMN
D) Based on the included recommended action or local policy or interaction with the user, or optionally based on the determination that the UE is now in the area of the DC, the UE may:
i) Register to same PLMN using another access technology that is not impacted
ii) Select another PLMN using the access technology that is impacted
iii) Transfer all sessions over another access technology that is not considered to be impacted. This may be done if the UE is registered over another access technology and the UE can connect to the PLMN using that access technology

To do so, the UE initiates the PDU session establishment procedure and sends the PDU session establishment request message to transfer the session from the impacted access (e.g. 3GPP access) to the non-impacted access (e.g. the non-3GPP access). The UE may indicate, e.g. using a new IE or by sending a new 5GMM cause, in the UL NAS TRANSPORT (which transports the 5GSM message) that the transfer is due to a DC.

Optionally, the UE may send a service request message (or control plan service request message if applicable) and include the Allowed PDU session status IE to indicate which PDU session should be transferred to the non-impacted access. Note that the UE may use this message optionally based on: The UE receiving a NOTIFICATION message with the access type of the message set to the impacted access type and optionally a new 5GMM cause code indicating a DC or e.g. temporary service failure, or any new message as described above.
iv) Save (or set) a local indication or flag that indicates the occurrence of a DC for the given PLMN and optionally impacted access type, optionally in addition to the location area or the time during which the DC is expected to last e.g. based on a default value or a received time value.

The UE may start a timer to guard the duration of the DC and/or may disable the impacted access type optionally if the UE is in the area of the DC (as determined by the UE based on the details herein), or optionally until the timer expires, or optionally until the UE receives an indication from the network that the DC has ended, or optionally if the UE makes a determination that the DC has ended using other means.
v) Based on the received indication about the DC, enter
   5GMM-REGISTERED.NO-CELL-AVAILABLE, or
   5GMM-REGISTERED.UPDATE-NEEDED, or
   5GMM-REGISTERED.PLMN-SEARCH, or
   5GMM-REGISTERED.LIMITED-SERVICE, or any similar substrate of the
   5GMM-DEREGISTERED state

The UE may take any of the actions proposed above when the UE detects that a DC has occurred via any other means of detection. For example, the UE may scan and/or read (e.g. using the 3GPP access) the broadcast information (e.g. SIBs) of another PLMN (e.g. a forbidden PLMN) where the information indicates that the PLMN accepts disaster roaming service. Optionally, the information may include the PLMN identity of the PLMN on which the UE is registered over the non-3GPP access. As such, all of the features herein would still apply for the UE regardless of the means by which the UE detects that a DC has occurred, thereby the proposals are not limited to cases for which the UE detects that a DC has occurred via a NAS message. As such, the UE may take any of the actions set out (and/or behave in any combination of the actions) whenever the UE detects that a DC has occurred (optionally over the 3GPP access) for the PLMN that the UE was registered to (optionally over the 3GPP access) or for the PLMN that the UE is optionally also still registered to over the non-3GPP access.

The details above are described in FIG. 3 noting that this is just an example solution and the figure is not to be considered to be limited to only the steps shown in it. Furthermore, the steps shown may occur in a different order and may involve other messages and signalling and steps that are set out herein but are not shown in the figure.

FIG. 3 shows certain steps relating to one sample embodiment and relates to messaging between a UE (100) and AMF (200), the AMF forming a part of at least one of the access networks to which the UE (100) is connected.

Step 301: the UE (100) is registered with the PLMN (or AMF (200)) over a first access e.g. 3GPP access

Step 302: the UE (100) is registered with the same PLMN (or same AMF (200)) over a second access e.g. non-3GPP access

Step 303: the AMF (200) determines that a DC has occurred and decides to inform the UE (100) about the DC e.g. this decision is based on the fact that the UE (100) is in connected mode optionally. If not, the AMF (200) may wait for the UE (100) to come to connected mode to inform it the UE (100) about the DC

Step 304: the AMF (200) notifies the UE (100) about the DC, where this notification may be done by sending a NAS message to the UE (100). The NAS message may be a new message or an existing message e.g. configuration update command message. The AMF (200) includes in the message at least one parameter as described herein. For example, the AMF (200) may include any combination of an indication about a DC, one or more impacted access types, a location area describing the location of the DC, a time period that determines the expected time that the DC is expected to last, a recommended action for the UE (100), a list of PLMN IDs that the UE (100) may attempt to access or register on, etc

Step 305: the UE (100) acknowledges the receipt of the notification by sending a new NAS message or an existing NAS message e.g. configuration update complete message

Step 306: the UE (100) optionally receives a notification of a DC optionally from the AMF (200) using a NAS message. The UE (100) determines that a DC has occurred e.g. based on a received indication from the AMF (200)(or by other means). Alternatively, the UE (100) may determine that a DC has occurred using any other means such as, but not limited to, determining that a DC has occurred by reading the SIBs (or broadcast information) of another PLMN (as described previously). The UE (100) may determine whether it is inside or outside the area of the DC e.g. based on comparing the UE's location to the determined area of the DC, where the latter may be based on information received from the AMF (200) or any other information. The UE (100) may, based on this determination, display to the user that the DC has occurred and may indicate the impacted access type(s) or the area, etc. The UE (100) may display options (e.g. using a graphical user interface-GUI) for the user to decide on e.g. remain on PLMN and use another access technology, disable impacted access(es), reselect to another PLMN (in this case a list of PLMNs may be displayed for the user e.g. based on the detected PLMN, etc). The user may interact with the device e.g. using a GUI, and indicate a preferred action

Step 307: based on local UE policy or based on received recommendation from the network or based on user interaction/decision (e.g. via a GUI), the UE (100) may decide to take one ore more actions as a result of the DC. For example, the UE (100) may decide to use the non-impacted access technology (e.g. non-3GPP access) and transfer each and every PDU session that was established over the impacted access (e.g. 3GPP access) over the non-impacted access (e.g. non-3GPP access)

Step 308: the UE (100) initiates the transfer of the PDU sessions that were established over the impacted access (e.g. 3GPP) to now be moved over the nonimpacted access (e.g. non-3GPP). The UE (100) sends the UL NAS TRANSPORT message and includes the 5GSM message (e.g. PDU session establishment request message) and may set the request type to “existing PDU session” and may include other information e.g. a new information element (IE) or a new 5GMM cause to indicate the reason for the transfer e.g. “network disaster condition”. The AMF (200) may use this indication to determine e.g. how many UEs are transferring their sessions due to DC etc or to not apply congestion control to such requests, etc.

Step 309: the UE (100) may start a timer, where the time value is based on a default value, a preconfigured value, or a value that was received optionally from the network (e.g. AMF (200)). The timer guards a period during which the UE (100) expects the DC to remain. The UE (100) may e.g. disable the impacted access type (e.g. 3GPP access) as long as the timer is running (or up until after half of the timer value has elapsed) or the UE (100) may select a different PLMN, where the selection may be based on a prioritized list of PLMNs, optionally where this list is preconfigured in the UE (100) or is received optionally from the network (e.g. AMF (200)).

The following provides further details or options relating to the foregoing and may be used in any combination in addition to all the other features or steps described herein.

The UE (100) may detect that a DC has occurred using any of the means described earlier (e.g. by reading the broadcast information from another PLMN which indicates that it is providing disaster roaming service, optionally for the PLMN on which the UE (100) was previously registered to over the 3GPP access or on which the UE (100) is registered to over the non-3GPP access).

The UE (100) may then take any of the following actions:

The UE (100) may determine, e.g. based on local policies, that the UE (100) prefers to use the 3GPP access, or that the UE (100) should use disaster roaming service. In order to do so (e.g. assuming that this is not possible if the UE (100) remains registered over non-3GPP access with the PLMN that experienced disaster on the 3GPP access), then the UE (100) may determine to deregister from the network by sending a deregistration request (e.g. over the access that is not affected by the DC, where this may for example be the non-3GPP access). The UE (100) may indicate that the reason for deregistration is due to a DC on another access, or that the reason is that the UE (100) wants to get the disaster roaming service. This indication may be sent using a new IE or an existing IE e.g. a new 5GMM cause value can be used or a new IE can be used.

Alternatively, based on the UE's policy (and optionally based on the UE (100) not being in 5GMM-CONNECTED mode on the non-3GPP access (on the PLMN which has DC on the 3GPP access in order to be eligible to get roaming service on another PLMN), the UE (100) may determine to autonomously release its NAS signalling connection and/or disable the non-3GPP access, and/or disable N1 mode for the non-3GPP access. The UE (100) may change its substate to
5GMM-REGISTERED.NO-CELL-AVAILABLE, or
5GMM-REGISTERED.UPDATE-NEEDED, or
5GMM-REGISTERED.PLMN-SEARCH, or
5GMM-REGISTERED.LIMITED-SERVICE, or any similar substate of the
5GMM-DEREGISTERED state. Upon any of these actions, or any combination of these actions, the UE (100) may then trigger a PLMN search to get disaster roaming service and/or attempt to register on a PLMN that offers disaster roaming service.

The UE (100) may take any of the actions after a timer expires, where the timer may be started when the UE (100) detects that a DC has occurred using any of the means that have been proposed herein. Upon expiry of the timer, the UE (100) may take any of the actions above e.g. deregister, release its NAS connection, disable N1 mode for non-3GPP access, or any combinations of these actions. Alternatively, upon expiry of the timer, the UE (100) (optionally in addition to any of the actions proposed above), may then trigger a PLMN search to get disaster roaming service and/or attempt to register on a PLMN that offers disaster roaming service. Upon registration over the 3GPP access with a PLMN that offers disaster roaming service, the UE may then enable its non-3GPP access (or the lower layers of the non-3GPP access) and/or N1 mode over the non-3GPP access, if any was disabled as proposed above.

The AMF (200) may provide the value of the timer to the UE (100), using any NAS message and/or existing/new IE. The value of the timer may be set to the value of the implicit deregistration timer. The timer may be set to a value by the UE (100) such that the value is: based on a received timer value from the network; based on a value that is determined based on implementation in the UE (100); based on a predefined value; or based on the value of the periodic update timer (or the default value that is known for this timer) or the value of the implicit deregistration timer.

For any of the above, the UE (100) may be configured with a policy or a predefined behaviour that the UE (100) needs to follow (hereafter referred to as “UE policy for getting disaster roaming service”). The UE (100) may also receive a UE policy for getting disaster roaming service from the network e.g. any network node such as the AMF (200)(using any existing or new NAS message, and/or any existing or new IE), or the UDM (e.g. using any container that may be sent to the UE (100) via the AMF (200), optionally using any NAS message by the AMF (200) for the purpose of sending it to the UE (100), and optionally using any new/existing IE by the AMF (200) for this purpose). The UE (100) may receive a UE policy for getting disaster roaming service, where the UE (100) should save this policy until a new policy is received that would cause the UE (100) to replace the previous policy with the new one or update the old policy. Based on the policy, the UE (100) takes specified actions such as those described above.

Optionally, the UE's policy may be based on the need of a particular service that the UE (100) knows to not be available over the 3GPP access, such as but not limited to: the UE (100) needing a service e.g. voice service, over the 3gpp, or the UE (100) needs a service that is known to not be available over the non-3gpp, or any other service that was there on 3gpp and that is not there on non-3gpp. Alternatively, the policy may be the lack of availability of a slice (identified by an S-NSSAI), or DNN, or slice and DNN combination, where any of these were being used by the UE over the 3GPP access and are not allowed to be used (or are not available) on the non-3GPP access. For example, the UE's allowed NSSAI for the non-3GPP access may not contain any such preferred slice or desired slice. As such, this may be a trigger or policy in the UE that would lead to the UE taking any of the actions as proposed above.

The user (or upper layers) may also interact with the UE (100), where the user/upper layers may e.g. in the case of manual PLMN selection, determine to use disaster roaming service. Based on this interaction and/or selection by the user/upper layers, the UE (100) may take any of the actions proposed above e.g. deregister over the non-3GPP access and attempt to use disaster roaming service on another PLMN using the 3GPP access

Optionally, the UE's policy may be based on a loss of a NAS signalling connection over the non-3GPP access. For example, if the UE (100) loses the lower layer connection over the non-3GPP access, or loses the NAS signalling connection over the non-3GPP access (e.g. the UE (100) is in 5GMM-IDLE mode over the non-3GPP access), the UE (100) may start a timer to guard the period of time before the UE (100) attempts to get disaster roaming service. If the timer expires, then the UE (100) takes any of the actions set out above e.g. the UE (100) may then trigger a PLMN search to get disaster roaming service and/or attempt to register on a PLMN that offers disaster roaming service. However, the UE (100) may stop the timer if the NAS signalling connection is re-established over the non-3GPP access (e.g. after the UE (100) enters 5GMM-CONNECTED mode over the non-3GPP access)

The UE's policy may be that if the UE (100) is running a BO timer for any form of congestion control e.g. mobility management congestion control, slice congestion control, DNN congestion control, or slice/DNN combination congestion control, then the UE (100) may determine to use disaster roaming service and take any of the actions above.

The UE's UE route selection policy (URSP) may require that a PDU session is preferred to be associated with the 3GPP access, and the UE (100) determines that the 3GPP access is not available due to a DC. In this case, the UE (100) may take any of the actions set out above e.g. attempt to get disaster roaming service and use the 3GPP access for the PDU session that is preferred to be established over the 3GPP access.

As such, based on the above, if the UE (100) can only receive/get disaster roaming service on another PLMN only when the UE (100) is not registered to the PLMN with DC over the non-3GPP access, then the UE (100) may, based on its local policies (as described above, in any combination), determine to take first set of actions, optionally after a timer expires, and optionally attempt to register with a PLMN (over the 3GPP access) which offers disaster roaming, optionally after the expiry of the timer.

The first set of actions may be any combination of those that were listed above e.g. UE (100) deregisters (over the non-3GPP access) from the PLMN that has experienced DC over the 3GPP access, and/or optionally the UE entering 5GMM-IDLE mode over the non-3GPP access, and/or the UE (100) entering any substate of the 5GMM-DEREGISTERED state over the non-3GPP access (where this state may be due to a UE initiated deregistration or a network initiated deregistration), and/or the UE disabling its N1 mode for the non-3GPP access, etc.

After the first set of actions, optionally after a timer expires, the UE (100) may take a second set of actions such as any of the combinations of actions listed above. For example, the UE (100) may perform PLMN search over the 3GPP access to find a PLMN that offers disaster roaming service and attempt to register on it. The UE (100) may then enable its (N1 mode for the) non-3GPP access if it was disabled, etc.

Note that the policies mentioned above may also be considered as conditions that the UE (100) needs to check. When any combination of these conditions are met, then the UE (100) may determine to access a PLMN which offers a disaster roaming service. For example, when the UE (100) detects that a DC has occurred on the 3GPP access of a PLMN on which its registered, by any of the means that have been mentioned herein, the UE (100) may verify if it is in 5GMM-IDLE mode (or in any sub-state of the 5GMM-DEREGISTERED state) over/for the non-3GPP access. If yes, the UE (100) may then immediately determine to use disaster roaming service on the 3GPP access with a PLMN that offers disaster roaming service, optionally after the expiry of a timer. E.g. the timer may be started in this case immediately after the determination of the availability of a DC, optionally because the UE (100) is already in 5GMM-IDLE mode (or in any sub-state of the 5GMM-DEREGISTERED state) over/for the non-3GPP access.

As such, for any of the above, the policy may be considered as a condition that the UE (100) needs to check and if any combination of the conditions are met, then the UE (100) may determine to take any of the actions set out above.

Note that the AMF (200) may also have a policy, or based on the UE's subscription, to force the UE (100) to use disaster roaming service when the AMF (200)(or PLMN) has experienced a DC on the 3GPP access, and optionally if the UE (100) is registered with the PLMN over the non-3GPP access (to the same AMF/PLMN), then the AMF (200) may force the UE (100) to use disaster roaming service on another PLMN by performing a network initiated deregistration procedure (e.g. AMF (200) sends a deregistration request message) with (or to) the UE (100). The AMF (200) may indicate a new 5GMM cause value indicating that the reasons is due to the availability of a DC on an access technology (e.g. a 3GPP access technology).

Note that although the above sets out that a first access that experienced DC is 3GPP and the UE (100) is considered to be registered over a second access such as non-3GPP, the opposite is also true and can apply in a similar manner if the first access is non-3GPP and the second access is 3GPP.

When the UE (100) attempts to use disaster roaming service in a PLMN, if the UE (100) supports both the 3GPP access and non-3GPP access, the UE (100) should first register over the 3GPP access and may then register over the non-3GPP access if needed.

If the UE (100) attempts to register on the non-3GPP access before registering on the 3GPP access, the AMF (200) should reject the registration procedure, where the determination to reject is based e.g. on a check of whether the UE (100) is already registered with the AMF (200) over the 3GPP access.

The AMF (200) can use any new/existing 5GMM cause value to indicate the reason for rejection. This is because the UE's location can only be known over the 3GPP access.

So far, the description has focused on the start of a DC, but the end of it requires consideration and the following relates to means for informing the UE (100) over one access about the end of a DC that relates to another access.

When the DC ends, if the UE (100) connected to the network over a non-impacted access, the network may take the same behaviour as proposed above to inform the UE (100) about the end of the DC. Note that the AMF (200) may take a subset of the actions above in this case.

For example, the AMF (200) may notify the UE (100) about the end of a DC over a previously impacted access, where this notification may be sent over a non-impacted access that the UE (100) is connected to, optionally after paging the UE (100) when applicable.

Note that informing the UE (100) about the end of a DC may be done by informing the UE (100) that normal service is now available over a previously impacted access technology.

It should be noted that the UE (100) may be on a different PLMN from the PLMN that experienced the DC. In this case, the UE (100) may be registered to the different PLMN using the access technology for which there was a DC on a different PLMN. For example, due to a DC on a previous PLMN, say PLMN X, and over an impacted access technology say 3GPP, the UE (100) may now be using the 3GPP access on another PLMN, say PLMN Y. Alternatively, the UE (100) may be on the same PLMN as the PMN that experienced the DC and the UE (100) may be using another access technology that was not impacted by the DC. For either of the above, the serving network (e.g. AMF (200)) may inform such a UE about the termination of a DC and that normal service can be resumed. The notification may include other types of information as set out below.

The notification from the AMF (200) may be a new NAS message or an existing NAS message and may include any of the following:

A) The AMF (200) may inform any UE that is in the area where normal service is now available (i.e. DC has ended) or outside the area where the DC has ended. The AMF may inform the UE (100) that is in connected mode or may e.g. page the UE (100) over the 3GPP access to transition the UE (100) to connected mode and then inform the UE (100) about the end of the DC.

B) An indication of an end of DC, optionally with an access type where the access type can refer to the previously impacted access type, or the access type over which the DC has ended or over which normal service can be resumed. Note that there may be more than one access type that can be sent in this case.

C) The network may indicate the nature of the DC e.g. “fire”, “earthquake”, “flood”, etc, that has now ended. This may be done by using dedicated descriptions or bitmap where e.g. a bit position of a new IE can be defined to refer to a set of well-defined DC that have ended.

D) A location information: where the information is not limited to one parameter only or one type of information only. This information may represent the area where normal service can be resumed or where there is no more a DC. This information may be any combination of the following:

i) a list of TAs or TAIs

ii) global cell identities

iii) a list of CAG (close access group) identities

iv) Geographic coordinates and optionally a shape description e.g. “rectangle”, “hexagon”, etc, that represents the area (specified by the coordinates) that has been affected. This information may also contain a center coordinate point and a radius parameter (or diameter parameter) to e.g. represent a circular area that may be impacted. Note that this is just an example and other parameters may also be used to represent other geographical areas and shapes.

v) A set of GPS coordinates

E) A set of PLMN identities, optionally in a priority order, where the order may be in descending priority or ascending priority. Each PLMN ID represents a target PLMN that the UE (100) may use or access in order to get normal service

F) An action that the PLMN recommends the UE (100) to do, where the action may be:

i) Access the PLMN (i.e. the PLMN for which the DC has ended)

ii) Optionally attempt to access the PLMN (i.e. the PLMN for which the DC has ended) using the access technology that was previously impacted (and is hence no longer impacted). For example, the previously impacted access may have been the 3GPP access over a PLMN X. The UE (100) may be connected to the PLMN X using a second non-impacted access e.g. non-3GPP access. The UE (100) may, due to a previous indication about a DC, be registered on another PLMN Y using the 3GPP access. The action from the network may now indicate that the UE (100) can return to PLMN X over the 3GPP access (i.e. over the access that was previously impacted and is no longer impacted).

iii) Optionally a time value after which the recommended action may be taken by the UE (100). E.g. the timer value may be a value that the AMF (200)(or current PMN) recommends that the UE (100) waits before taking the indicated action e.g. before reattempting to access the PLMN over the access technology that was affected by the DC.

iv) Whether or not the UE (100) should transfer its PDU session(s) from the nonimpacted access over to the access that is no longer impacted (i.e. over which service is now available). The indication may be in the form of a bitmap, where a new IE can be used for this bitmap and each bit may would correspond to a PDU session ID and the bit value would indicate whether the PDU session with the corresponding PDU session ID should be transferred. For example, the value ‘l’ may be used to mean that the PDU session corresponding to this bit should be transferred, and ‘O’ may mean that it should not be transferred. Note that this is just an example and other methods can be used to indicate whether a PDU session should be transferred or not.

The AMF (200) may optionally include a time value, optionally per PDU session ID or for all PDU sessions, that indicates a period of time that the network (e.g. AMF (200) and/or SMF) will keep the PDU session as active and hence the UE (100) can transfer the PDU session within this time. The AMF (200) may start a timer with the indicated value (optionally after sending the notification to the UE (100)), optionally per PDU session or for all PDU session. After the expiry of this timer, if the UE (100) does not transfer the PDU session then the AMF (200), for each PDU session that was not transferred, will mark the PDU session as released and inform the SMF to also release the PDU session. On the other hand, if the UE (100) transfers the PDU session(s) before the time expires, the AMF (200) may stop the timer. Alternatively, the AMF (200) may stop the timer when the UE (100) transfers all of its PDU sessions from the impacted access over to the non-impacted session.

The AMF (200) should send a new 5GMM cause value to indicate the reason why the notification (as explained and described above) is being sent. This cause value may be “network disaster condition ended” or a more generic reason such as “service restored”.

When the UE (100) gets a notification that a DC has ended (or that normal service is now available), e.g. using a new NAS message or an existing NAS message, the UE (100) may take any of the previous actions that a reset out above, however where the UE (100) may attempt to return to use the previous access that was impacted and register to the PLMN over the previous access that was impacted (and is no longer impacted).

For example, if the previously impacted access was the 3GPP access, the UE (100) may, based on the notification that the DC has ended, send a Registration Request over the 3GPP access. Note that the use of a 3GPP access as the impacted access is just an example and the proposal can apply to any access. The UE (100) may search for a PLMN using the access that was previously impacted and when found the UE (100) may then register over the access technology. Therefore, if the access technology was disabled, the UE (100) may first enable it, use it for PLMN search, and then register (i.e. send a registration request) over the access technology (that is no longer impacted as notified to the UE (100) optionally by the network).

The UE (100) may take any of the following actions after receiving a notification that a DC has ended (noting that the notification of the end of DC may be received from any network or PLMN, and may be in reference to a known PLMN (or PLMN and access technology, where the access technology is the access that was previously impacted by a DC), where the PLMN may be the same PLMN that is sending the notification, or a previous PLMN from on which a previous DC had occurred:

A) The UE (100) may determine that a DC has ended for:

i) An access technology that was previously determined to experience a DC

ii) A PLMN for which the UE (100) previously determined that a DC exists

iii) A PLMN and access technology combination for which the UE previously determined that a DC existed

iv) Note: the determination may be based on a notification message, and optionally other information e.g. PLMN, access type, or PLMN and access type combination, for which a DC is indicated to have ended (or for which normal service is indicted to be possible)

B) The UE (100) may delete a flag which indicates that a DC exists for a PLMN (or PLMN and access technology combination), or may set the value of the flag such that it indicates that no DC exists

C) The UE (100) may enable an access type for which the notification indicates that a DC has ended

D) The UE (100) may perform PLMN search to return to the PLMN over which a DC no longer exists

E) The UE (100) may take any of the actions above optionally after starting a timer and the timer expires, where the timer value may be:

i) Based on default or preconfigured timer

ii) Based on a timer value that is received in the notification message optionally from the network (or AMF (200))

iii) Note that this timer value is to avoid having many UEs return to the same PLMN and thereby congesting the PLMN

F) The UE (100) may send a NAS message to acknowledge the receipt of the notification. The acknowledgement may be done with a new NAS message or with existing NAS message e.g. configuration update complete or notification response, etc.

G) The UE may determine the location where the DC has ended based on the location information that was received (optionally from the network). This may be done as described earlier for the case when the UE (100) determines the location after a notification of a DC is received as described previously

H) The UE (100) may display a message to the user to notify of the end of the DC or the resumption of normal service. The message may include the access type(s) that is no longer impacted or for which no DC exists anymore. The message may also indicate to the user whether the UE (100) is inside or outside the area where normal service can be resumed. The UE may also display the nature of the DC that has ended e.g. “fire”, “earthquake”, “flood”, where this display may be done using words or icons that represent a certain DC. This information may be based on the information that the UE (100) has received, optionally as notified by the network based on the proposals above. The UE (100) may then receive a recommended action from the user e.g. to return to the PLMN, optionally over a previously impacted access technology, where a DC occurred but is now ended

I) Based on the included recommended action or local policy or interaction with the user, or optionally based on the determination that the UE is now in the area of the DC, the UE (100) may

i) Return to the PLMN that is no longer impacted by the DC. The UE (100) may take any of the actions proposed above e.g. enable an access technology that was previously impacted, search for a PLMN that is no longer impacted by a DC, and attempt to register on that PLMN.

ii) If the UE (100) is already registered to the PLMN (for which a DC has ended) using a second access technology, the UE (100) may transfer all or some sessions over the access technology that is no longer impacted by a DC. The method to do so should be the same as proposed earlier for the case when the UE (100) transfers a PDU session from an impacted access to a non-impacted access for the same PLMN/AMF (200).

J) The UE (100) may register over the access technology that is no longer impacted and the UE may register to the PLMN for which a DC has ended over the access technology that is no longer impacted by the DC.

K) The UE (100) may change its 5GMM registration state over the impacted access technology to be 5GMM-REGISTERED.NORMAL-SERVICE, or may enter any other substrate of the 5GMM-REGISTERED state.

L) Alternatively, the UE (100) may send a service request (or control plane service request) message over the access technology that is determined to no longer have a DC.

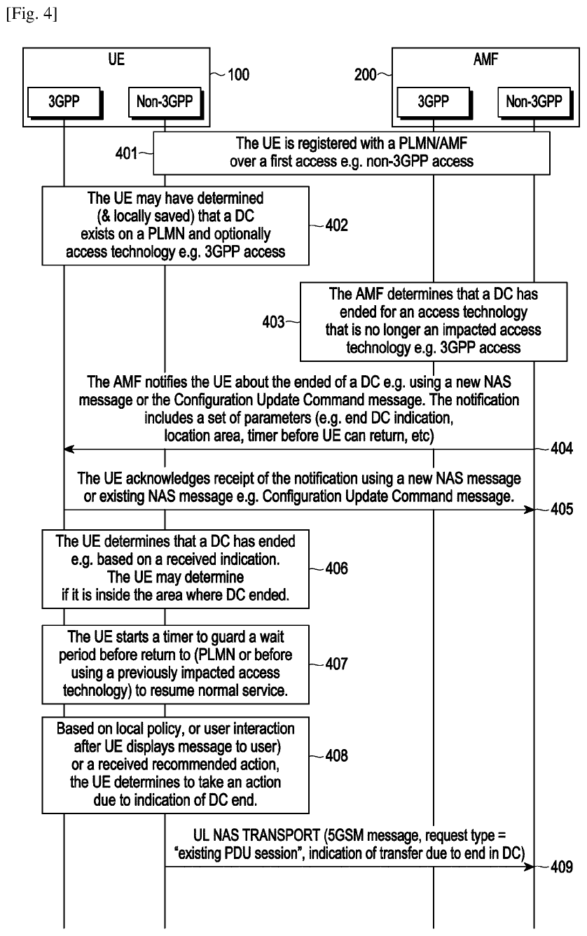

FIG. 4 shows certain steps relating to one sample embodiment and relates to messaging between a UE (100) and AMF (200), the AMF (200) forming a part of at least one of the access networks to which the UE (100) is connected.

Step 401: the UE (100) is registered with the PLMN (or AMF (200)) over a first access e.g. non-3GPP access

Step 402: the UE (100) may have saved a local flag or indication about a DC that is applicable to a PLMN, and optionally over an impacted access technology e.g. 3GPP access

Note: step 402 may occur before step 401

Step 403: the AMF (200) determines that a DC has ended for a PLMN, or optionally for an access technology that was previously impacted (and hence no longer impacted by the DC)

Step 404: the AMF (200) notifies the UE (100) with any NAS message (new or existing) that a DC has ended or that the UE (100) can resume normal service. The notification may include the PLMN over which normal service can be resumed, and/or the access technology over which the normal service can be resumed (i.e. the access technology that is no longer considered to be impacted by a DC). The AMF (200) may also include a timer whose value indicates the time before the UE (100) can attempt to return to use normal service for the optionally indicated PLMN and/or optionally indicated access technology. The area in which the DC is determined to have ended may also be included. A recommended action may be also included e.g. transfer sessions from one access to another access that is no longer impacted, etc

Step 405: the UE (100) acknowledges the receipt of the notification

Step 406: the UE (100) determines that a DC has ended optionally based on a received notification from the network, optionally the UE (100) determines this for a certain PLMN (e.g. based on a received PLMN ID, and/or for a certain previously impacted access technology e.g. based on a received access technology type or a saved access technology type that was previously determined to be impacted). Alternatively, the UE (100) may determine that a DC has ended using any other means such as, but not limited to, detecting the availability of its previous PLMN (e.g. the lower layers in the UE (100) perform a scan and indicate the availability of the PLMN to the NAS, where the PLMN is the previous PLMN that had experienced a DC).

Step 407: the UE (100) may start a timer (whose value is based on a default/configured value or a value that is received from the network) to guard a time before which the UE (100) can return and access the PLMN, optionally over the previously impacted access technology (that is no longer impacted). The UE (100) may enable the access technology if it was disabled, or the UE (100) may optionally do so when the timer expires. The UE (100) may perform PLMN search, optionally after a timer expires (although this is not shown in FIG. 4)

Step 408: the UE (100) may take a certain action as e.g. recommended/indicated in the received notification (optionally from the network) or based on a user interaction and decision, or the UE (100) may enable an access technology (e.g. 3GPP) that was previously disabled or the UE (100) may perform a PLMN search (or any combination of these actions in possibly a different order).

Step 409: the UE (100) may decide to transfer some sessions from one access technology (e.g. non-3GPP access) to another access technology for which a DC has ended (or for which the UE (100) has determined that normal services can be received after a determination of an end to a DC). Alternatively, and although not shown in the figure, the UE (100) may register to a PLMN (for which a DC is determined to have ended) using an access technology that is determined to no longer have a DC. The UE (100), after registration, may then attempt to transfer sessions over the access technology that is no longer affected by a DC.

Note that in all of the aforementioned, the steps and processes set out can occur in any sequence and in any combination.

Note that in relation to all of the aforementioned, the PLMN that experiences a DC may be the PLMN that sends a notification to the UE (100) that a DC has occurred, and may be the same PLMN that later sends a notification to the UE (100) that a DC has ended. The notification may be sent over an access technology over which a DC does not exist.

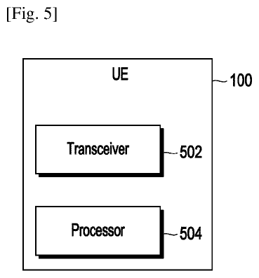

FIG. 5 is a block diagram of a UE in accordance with various embodiments. In an embodiment, the UE (100) includes a transceiver (520) and a processor (540).

The transceiver (520) is configured to communicate internally between internal hardware components and with external devices (e.g. the AMF (200)) via one or more networks. The transceiver (520) is configured to connect to one or more networks over at least one of a 3GPP access and an non-3GPP access. The transceiver (520) may include an electronic circuit specific to a standard that enables wireless communication.

The processor (540) is coupled to the transceiver (520). The processor (540) is configured to perform processes in accordance with various embodiments. For example, the processor (540) may perform the operation of the UE (100) described above.

The processor (540) may include one or more processors, may be a general-purpose processor, such as a central processing unit (CPU), an application processor (AP), or the like, a graphics-only processing unit such as a graphics processing unit (GPU), a visual processing unit (VPU), and/or an artificial intelligence (AI) dedicated processor such as a neural processing unit (NPU).

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a field programmable gate array (FPGA) or application specific integrated circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of a user equipment (UE), comprising:
identifying a disaster condition for a first network;
identifying whether the UE is in a registered state and a connected state over a first access based on the identified disaster condition; and
performing a disaster roaming based on an identification that the UE is not in the registered state and the connected state over the first access.

2. The method of claim 1, wherein the identifying of the first network with the disaster condition comprises:
receiving information broadcasted from a second network; and
identifying the first network with the disaster condition based on the received information.

3. The method of claim 2, wherein the received information includes information indicating accessibility for a disaster roaming service.

4. The method of claim 3, wherein the performing of the disaster roaming comprises:
receiving the disaster roaming service from the second network based on the received information; and
performing registration to the second network.

5. The method of claim 1, wherein the first network is a network connected over a second access.

6. The method of claim 5, wherein the first access is a non-3GPP access and the second access is a 3GPP access.

7. A user equipment (UE), comprising:
a transceiver; and
at least one processor coupled to the transceiver,
wherein the at least one processor is configured to:
identify a disaster condition for a first network,
identify whether the UE is in a registered state and a connected state over a first access, based on the identified disaster condition, and
control the transceiver to perform a disaster roaming based on an identification that the UE is not in the registered state and the connected state over a second access.

8. The UE of claim 7, wherein the at least one processor is further configured to:
control the transceiver to receive information broadcasted from a second network, and
identify the first network with the disaster condition based on the received information.

9. The UE of claim 8, wherein the received information includes information indicating accessibility for a disaster roaming service.

10. The UE of claim 9, wherein the at least one processor is further configured to:
control the transceiver to receive the disaster roaming service from the second network based on the received information, and
perform registration to the second network.

11. The UE of claim 7, wherein the first network is a network connected over a second access.

12. The UE of claim 11, wherein the first access is a non-3GPP access and the second access is a 3GPP access.
